(19) United States
(12) Patent Application Publication
(10) Pub. No.: US 2003/0117368 A1
(43) Pub. Date: Jun. 26, 2003

(54) Internet access viewing device

(76) Inventor: Christen K. Pedersen, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/032,364

(22) Filed: Dec. 21, 2001

(51) Int. Cl. G09G 5/00

(52) U.S. Cl. 345/156

(57) ABSTRACT

A display projection system. In one embodiment, the display projection system comprises an image generator for providing a beam. The beam comprises data to be displayed via the display projection system. The display projection system is further comprised of an optical component to provide collimation of the beam. The data is viewable via a projected display, and the display projection system is implementable in a portable electronic device.

### TECHNICAL FIELD

The present invention relates to accessing and the displaying of information. More particularly, the present invention provides a portable electronic device uniquely configured to access and display information.

### BACKGROUND ART

The continued advancements in technology have enabled the further miniaturization of the components required to build computer systems. Technological advancements have also been material toward providing improvements in processing power, system performance, communication, and memory/storage capacities associated with computer systems. Additionally, advancements in technology has furthered the development of portable computer systems.

Accordingly, substantial improvements to existing portable computer systems, e.g., a laptop computer system, have been realized. It is well known that currently available laptop computer systems now possess the computing power and capacities that were once primarily found in a desktop or workstation computer system, but with the added benefit of portability. Additionally, current laptop computer systems are configured to provide displays for viewing information that are nearly equivalent in size to displays associated with full sized computer systems, such as desktop and/or workstation computer systems. However, it is appreciated that increased costs are associated with laptops having larger displays.

Laptop computer systems, such as laptop computer 3 in prior art FIG. 1, are, however, not without some drawbacks. One considerable drawback is that laptops are relatively expensive when compared to an equivalently equipped desktop or workstation computer. It is also noted that while the overall weight of a laptop has been reduced, the weight of an average laptop ranges from around seven to nine pounds. It is appreciated that there are laptop models that weigh somewhat less, but at a substantially higher cost. A further drawback is in transporting a laptop, as it is recommended a laptop case be used to provide protection against accidental or inadvertent damage.

Additionally, as a result of the continued advancements in technology, new categories of computer systems have been developed. One of the newer categories of computer systems developed has been the handheld or palmtop computer system, commonly referred to as a PDA (portable digital assistant), e.g., PDA 4 of prior art FIG. 2. Other examples of handheld computer systems can include, but are not limited to, electronic address books, electronic day planners, electronic schedulers, and the like.

A handheld computer is a computer that is small enough to be held in the user's hand and as such is “palm-sized.” As a result, handhelds are readily carried about in the user's briefcase, purse, and in some instances, the user's pocket. By virtue of its size, the handheld computer, being inherently lightweight, is therefore exceptionally portable and convenient.

Handheld computers are not without some drawbacks. Because of the diminutive size of the handheld, the size of the viewing screen of the display device incorporated within the handheld has been substantially reduced to comply with the form factor of the handheld. In prior art FIG. 2, display screen 5 of handheld computer 4 has a viewing area with dimensions that are approximately two and one quarter by two and one quarter inches. Further, the quality of the display is affected by the reduced size of the handheld, and accordingly the display screen. Additionally, displays for the handheld are commonly greyscale, but some newer models are configured with color display functionality, but with display size constraints analogous to those monochrome or greyscale displays. It is noted that those handhelds equipped with color displays are commonly priced substantially higher that those with greyscale or monochrome displays.

Another of the newer categories of electronic devices are projection display devices. A projection display device is externally connected to an existing computer system, such as a desktop or laptop computer, which then provides the data for the projected display. Most of the projection display devices currently being manufactured are designed to produce wall-sized images in brightly lit conference rooms. To provide such a projected display, the size of the device has been a secondary concern. Accordingly, most projection display devices are still larger than the notebook computers to which they are connected, in spite of efforts to design smaller, more portable projectors.

Thus, it would be advantageous to provide a portable computer system that combines the portability of handheld devices with the large display screen size of a laptop computer. It would also be advantageous to provide a portable computer system that is configured with integrated projected display functionality. It would be further advantageous to provide a portable computer system that is as easily transportable as it is putting a pen in your pocket.

### DISCLOSURE OF THE INVENTION

The present invention provides a projection display apparatus that is implementable within a portable electronic device. In one embodiment, the display projection system is comprised of an image generator for providing a beam. The beam is comprised of data that is to be displayed via the projection display system. The display projection system is further comprised of an optical component which is adapted to provide collimation of the beam. The data in the beam is viewable via the projected display, and the display projection system is implementable in a portable electronic device. The adjustable reflecting mechanism is further adapted to direct the scanning of the beam.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is an illustration of a prior art laptop computer.

FIG. 2 is an illustration of a prior art handheld computer.

FIG. 3A is an illustrated front-view of a portable electronic device, in accordance with one embodiment of the present invention.

FIG. 3B is an illustrated rear-view of a portable electronic device, in accordance with one embodiment of the present invention.

FIG. 4 is an illustrated view of a display projection component of a portable electronic device, in accordance with one embodiment of the present invention.

FIG. 5A is an illustrated view of a portable electronic device configured with a support mechanism, in accordance with one embodiment of the present invention.

FIG. 5B is an illustrated view of a portable electronic device supported with a stand, in accordance with one embodiment of the present invention.

FIG. 5C is an illustrated view of the portable electronic device of FIG. 5B with multiple input devices, in accordance with one embodiment of the present invention.

FIG. 6A is a block diagram of circuitry and components integrated within a portable electronic device, in accordance with one embodiment of the present invention.

FIG. 6B is a block diagram of circuitry and components integrated with the portable electronic device of FIG. 6A configured with personal area network functionality, in accordance with one embodiment of the present invention.

FIG. 7 is an illustration an exemplary network environment including a portable electronic device, in accordance with one embodiment of the present invention.

FIG. 8 is an illustration of a portable electronic device connected to other computer systems and the Internet via a stand device, in accordance with one embodiment of the present invention.

FIG. 9 is an illustration of a network of devices coupled using wireless connections, in accordance with one embodiment of the present invention.

FIG. 10 is an illustration of a data packet format, in accordance with one embodiment of the present invention.

FIG. 11 is an illustration of a header format in a data packet, in accordance with one embodiment of the present invention,

FIG. 12 is a diagram illustrating a transfer of data packets between receiving and transmitting devices, in accordance with one embodiment of the present invention.

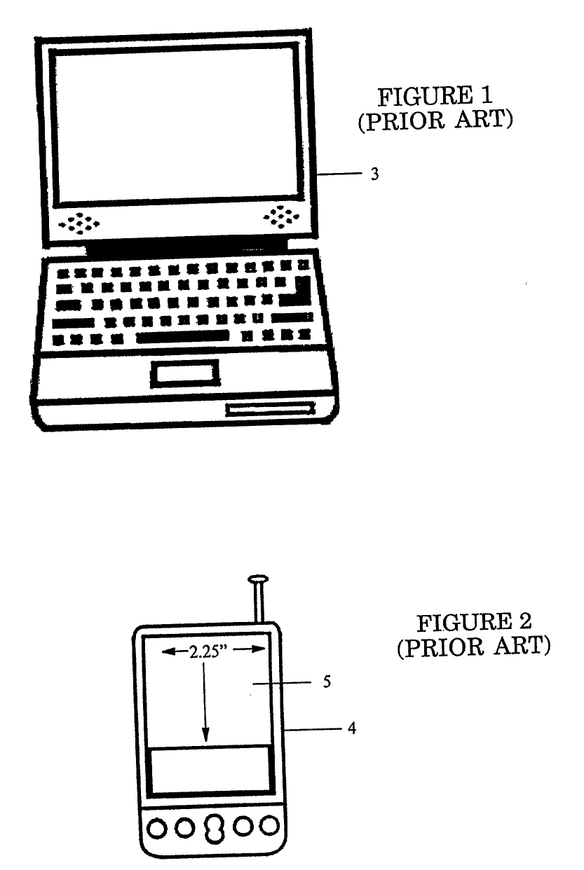

### MODES FOR CARRYING OUT THE INVENTION

A pen-type portable electronic device (PTPED) with display projection is described. In the following description, for purposes of explanation, numerous specific details are set forth in order to provide a thorough understanding of the present invention. It will be obvious, however, to one skilled in the art that the present invention may be practiced without these specific details. In other instances, well-known structures and devices are shown in block diagram form in order to avoid obscuring the present invention.

The present invention is discussed primarily in the context of a portable electronic device, such as a pen-type or pen-like computer system. However, it is appreciated that the present invention can be used to interact with other types of devices that have the capability to access some type of central device or central site, including, but not limited to, portable electronic devices.

It is appreciated that the acronym PTPED, and pen-type portable electronic device, which the acronym represents, will be used interchangeably throughout the following disclosure to represent the present invention, a PTPED (pen-type portable electronic device) 100.

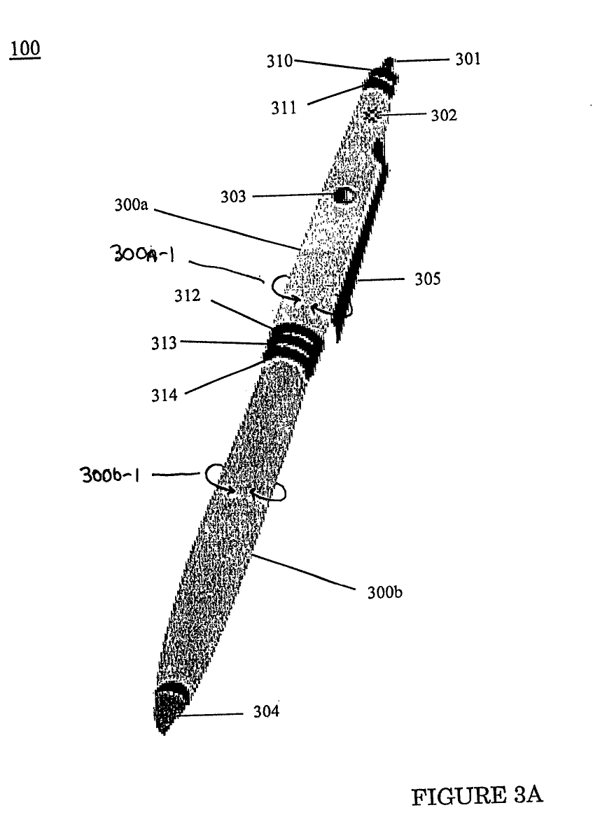

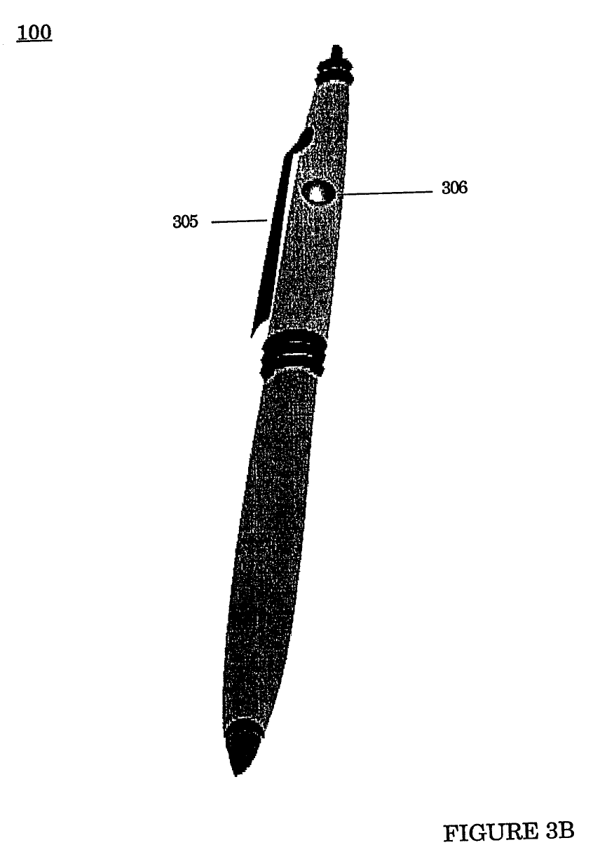

FIG. 3A is an illustrated front-view of a PTPED (pen-type portable electronic device) 100, in accordance with one embodiment of the present invention. At the top of, or embedded in PTPED 100 is an antenna 301, for transceiving radio signals. In one embodiment, antenna 301 has extendable and retractable functionality. In one embodiment, antenna 301, may be replaced with a push-button activation function, such that when push-button antenna 301 is pressed down, it may initiate a signal analogous to a mouse click function, e.g., a left or right mouse click. It is appreciated that antenna 301 is enabled to transceive nearly any wireless communication protocol, such as Bluetooth, wireless LAN, or WAN protocols.

MISP (microphone/speaker) 302, shown in one embodiment below antenna 301, is for receiving a user's voice commands and for providing audible output of audio signals. In one embodiment, MISP 302 interprets and then initiates computer implemented processes in response to a user's voiced commands.

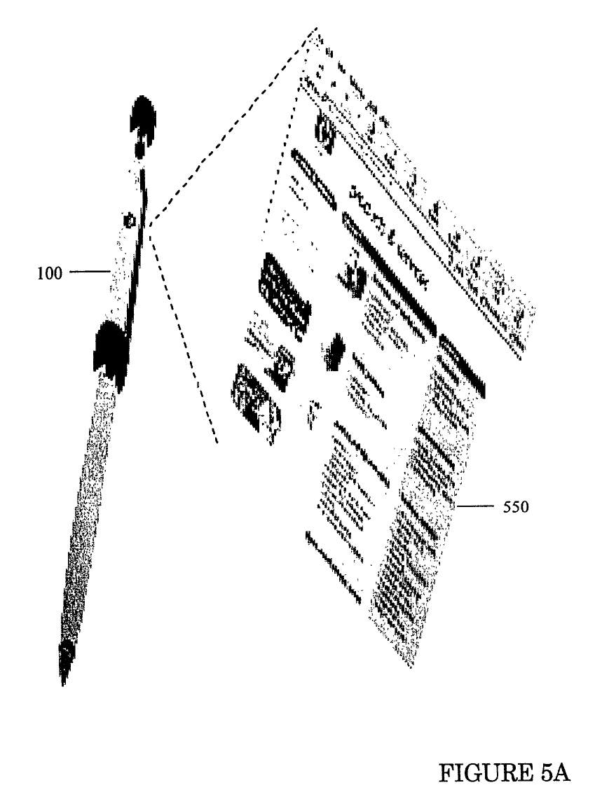

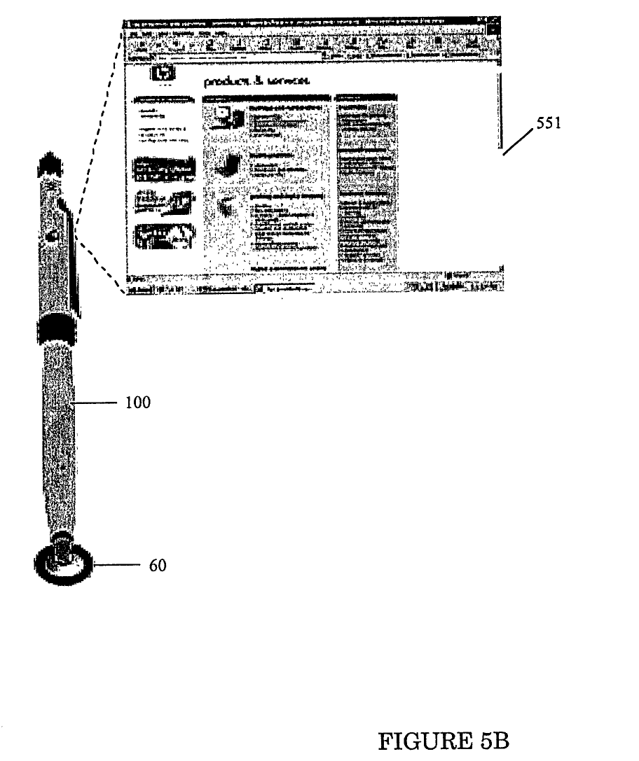

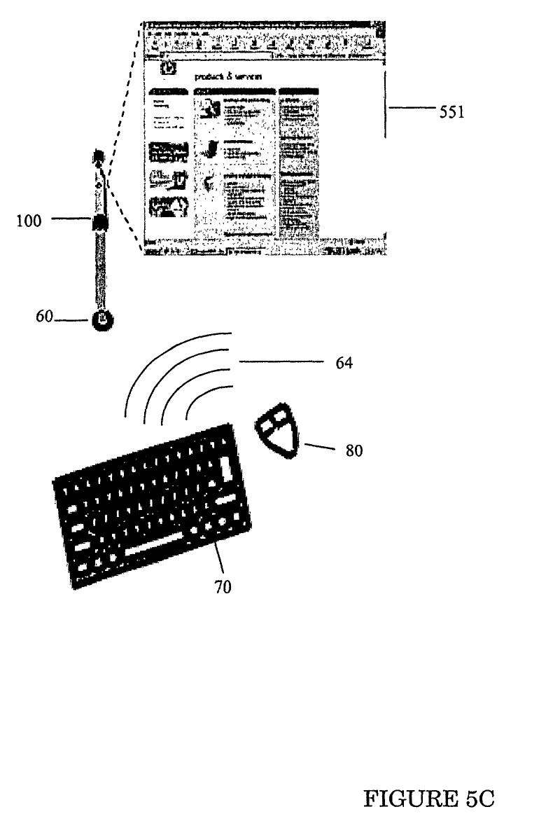

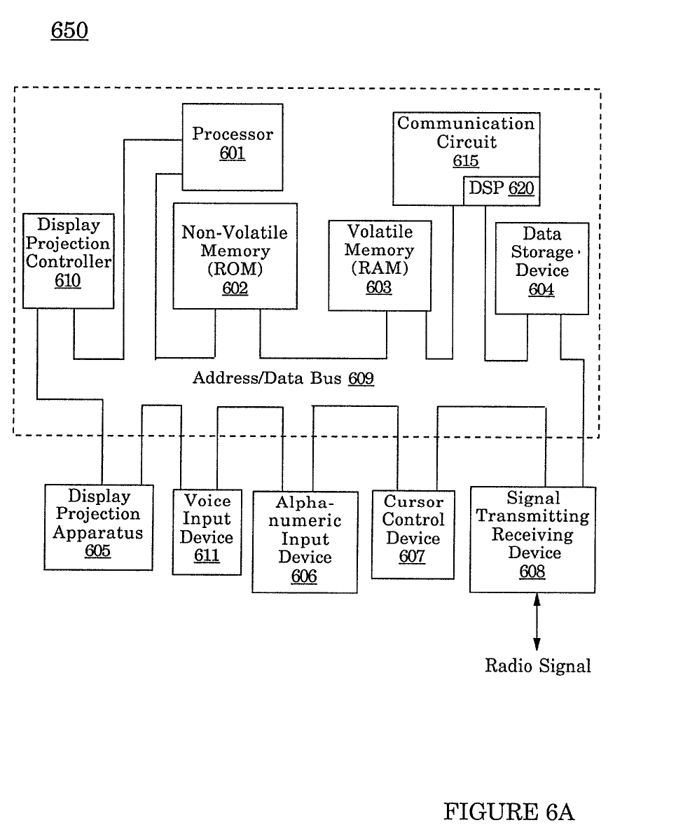

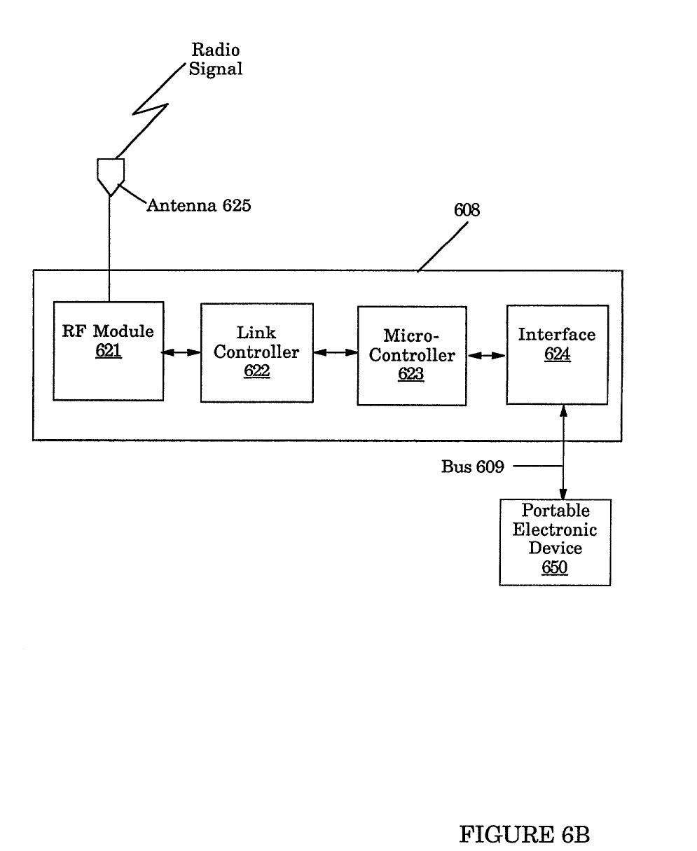

CPD (cursor placement device) 303, shown in one embodiment below MISP 302, is for controlling a cursor. In one embodiment, as the projection display device projects a display, for example web page 550 of FIG. 5A, there is a displayed dot within the projected display. To select a function of the display or to go to a different web page, e.g., web page 551 of FIG. 5B, a user tilts and rotates PTPED 100. This changes the angle of the projection, as controlled by display projection controller 610 of FIG. 6A, and while the projected display is moved/repositioned, the dot remains in the same place. The user then aligns the dot with the function to be performed or to a web page link to which the user wishes to view, and then clicks on CPD 303 to initiate the action.

Still referring to CPD 303 of FIG. 3A, in another embodiment, CPD 303 is configured as a conventional cursor control device, functionally analogous to a joystick type-input device commonly found on laptop computers. In the present embodiment, a user would apply pressure to CPD 303 to align the cursor with the desired function or link, and then press down to “click” CPD 303 to initiate the action. In another embodiment, a user may press down on retracted antenna 301 to click CPD 303 to initiate the action.

Still referring to FIG. 3A, at the bottom is input device 304. In one embodiment, input device 304 is configured as a handwriting memory unit, such that a user may write information that is then interpreted by a input device circuit, e.g., alphanumeric input device 606 of FIG. 6A, and then initiates PTPED 100 to perform in accordance with the user's written commands. In another embodiment, input device 304 can be configured as a OCR (optical character recognition) device. In this instance, input device 304 can scan-in information, such as a web page address, e.g., a URL (uniform resource locator). The scanned URL can be inserted into the “location” section of a browser window, and once inserted, the user can then initiate the browser to go to the desired web page. In yet another embodiment, input device 304 can be configured as an ink and/or pencil type writing implement. It is appreciated that embodiments of the present invention are such that PTPED 100 can be configured with handwriting memory functionality only, handwriting memory and OCR, or handwriting memory, OCR, and ink and/or pencil type writing functionality. It is further appreciated that only one of the three above listed input devices are operable at any one time. Additionally, the above list of input device types should not be considered exhaustive, but used to illustrate the variety of input devices that may comprise one embodiment of the present invention.

Still referring to FIG. 3A, it is noted that, in one embodiment, PTPED 100 has an upper portion 300a and a lower portion 300b. Upper portion 300a and lower portion 300b of PTPED 100 are configured to independently rotate, in either direction, about the vertical axis, as indicated by arrows 300a-1 and arrows 300b-1, respectively. In one embodiment, stationary ring 313 provides a fixed point about which upper portion ring 312 may rotate and about which lower portion ring 314 may rotate. In one embodiment, rotatable portions 300a and 300b can be configured to activate many of the functions and devices integrated within PTPED 100.

Still referring to FIG. 3A, in one embodiment, rotating upper portion 300a in a clockwise direction can activate OCR 304, while rotating upper portion 300a in a counter clockwise direction will deactivate OCR 304. In another embodiment, rotating lower portion 300b in a clockwise direction can activate handwriting memory unit 304, while rotating lower portion 300b in a counter clockwise direction will deactivate handwriting memory unit 304. In yet another embodiment, rotating upper portion 300a in one direction and rotating lower portion 300b in an opposite direction can activate pen and/or pencil writing device 304, and reversing the rotations can deactivate pen and/or pencil writing device 304.

Still referring to FIG. 3A, shown toward the top, in one embodiment, are rings 310 and 311, rotatable about the vertical axis of PTPED 100. In one embodiment, ring 310 can be rotated in one direction to activate PTPED 100 and rotated in an opposite direction for deactivation. In one embodiment, ring 311 can be rotated in a direction to provide focusing of the projected display. In yet another embodiment, when ring 310 has been rotated to activate PTPED 100, pocket clip 305 can be available to provide mouse click functionality, such that pressing pocket clip twice is analogous to a double-click on a mouse, e.g., mouse 80 of FIG. 5C.

It is appreciated that the above list of functions activated by rotating portions of PTPED should not be considered exhaustive, but used to illustrate the variety of rotations and functions that can be incorporated into PTPED 100, and which may comprise one embodiment of the present invention. It is further appreciated that multiple function buttons may be present upon the outer surface of PTPED in various numbers, shapes, and sizes that, in one embodiment, can enhance the functionality of PTPED 100.

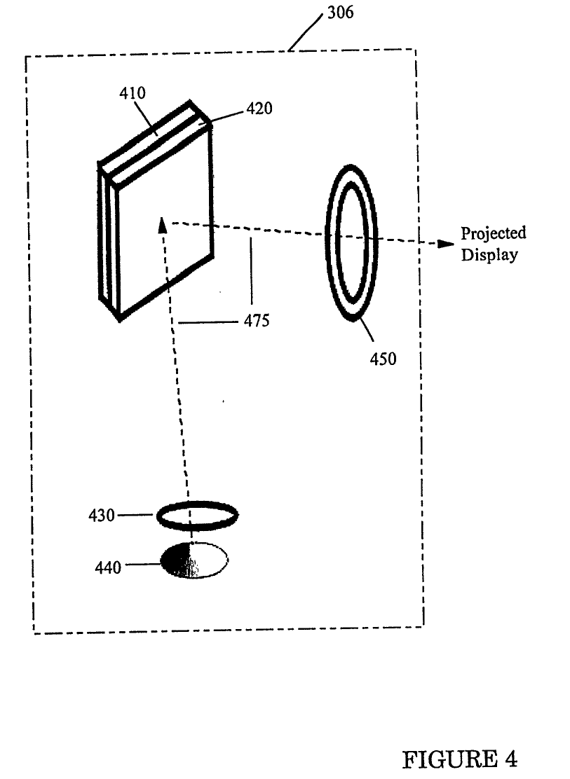

FIG. 3B is, in one embodiment, an illustrated rear-view of a PTPED 100. Shown in FIG. 3B is a projection display apparatus, e.g., projection display apparatus 306, described in detail in FIG. 4. Projection display apparatus 306 is adapted to project a display onto nearly any surface, and while a flat surface is preferred, it is not required to facilitate the display functionality provided by PTPED 100.

FIG. 4 is an illustration of the display projection apparatus 306 of FIG. 3B, showing the projection components integrated within PTPED 100, in one embodiment of the present invention. In the present embodiment, micromirror-scanned laser technology is implemented to provide the projected display. Micromirror-scanned laser technology can be considered as a type of laser-pointer with a steerable micromirror assembly that scans the laser to paint (project) an image.

Still referring to FIG. 4, in one embodiment, by turning the laser on and off as it is scanned, a monochrome image can be produced. In another embodiment, by modulating the intensity of the laser, a gray-scale and/or monochrome image can be produced. In yet another embodiment, a combination of intensity modulation and turning the laser on and off may be utilized to produce an image. It is appreciated that the above techniques of producing an image take advantage of human visual response which integrates the scanned image into a single view. Producing an image in this manner has an additional advantage in that, in one embodiment, the image produced is “focus-free.” In an optional embodiment for enhancing the projected display, there may be an advantage to “blurring” the laser spot size selectively based upon viewing distance to form a more completely painted image.

It is appreciated that the utilization of micromirror-scanned laser technology for a projected display provides numerous advantages over conventional displays. For example, the size of the light source can be significantly reduced. Additionally, a cooling system (e.g., cooling fans and/or heat sinks) are unnecessary. Further, by virtue of the smaller imaging device, less light is needed, less heat is generated, and less thermal dissipation is required. Also, instead of dc power supplies and/or transformers, less complicated power systems such as disposable or rechargeable batteries can be implemented.

Still referring to FIG. 4, a solid state laser, e.g., laser 440 is configured to generate a laser beam 475. Laser beam 475 contains the data and/or information that will be projectably displayed to a user. The information to be displayed can be nearly any type of data that is customarily viewed by a user on a conventional display device, such as a CRT display. In one example, the data can be a text document, such as a business document. In another example, the data can be a spreadsheet. In another example, the data can be a web page, e.g., web page 550 of FIG. 5A or web page 551 of FIG. 5B.

Still referring to FIG. 4, laser beam 475 containing the data to be projected passes through a beam collimator, e.g., optic beam collimator 430. Laser beam 475 is then scanned by a micromirror or multiple micromirrors, e.g., micromirror 410 and micromirror 420. In one embodiment, micromirror 410 provides for a horizontal reflection of laser beam 475 and micromirror 420 provides for a vertical reflection of laser beam 475. In another embodiment, micromirror 410 provides for a vertical reflection and micromirror 420 provides for a horizontal reflection of laser beam 475. Subsequent to scanning of laser beam 475 by micromirrors 410 and 420, laser beam 475 is reflected outward, such that the projected display is viewable to a user. In one embodiment, an optional optical attenuator, e.g., optical attenuator 450 is utilized to decrease intensity in laser beam 475, such that the image projected is more easily viewed.

Still referring to FIG. 4, it is appreciated that alternative technologies may also be utilized, e.g., transmissive LCD projection and reflective DLP (digital light panel) projection, to provide display projection functionality. In utilizing the alternative technologies, a broad-spectrum light source (e.g., sequential LED, white LED, incandescent) would illuminate the imaging device which would then be focused (adjustable by a user) by an optical assembly to form an image at the desired viewing distance.

FIG. 5A shows PTPED 100 projecting a web page in a generated display, in accordance with one embodiment of the present invention. In this implementation, PTPED 100 is held in a user's hand, and through display projection apparatus 306 (FIG. 4), a web page, e.g., web page 550 is projected and viewably displayed. In one example, web page 550 can be projected onto a surface, such as the top of a desk. In another example, web page 550 can be projected onto a piece of paper on top of a desk. In another example, web page 550 may be projected onto a hand, e.g., the hand of a user utilizing PTPED 100. It is appreciated that web page 550 may be projected onto nearly any surface of nearly any size and nearly any shape or texture.

FIG. 5B shows PTPED 100 projecting a web page 551 in a generated display, in accordance with one embodiment of the present invention. In FIG. 5B, PTPED 100 is supported in a vertical orientation by stand 60, adapted, in one embodiment, to passively retain PTPED 100 is a vertical position. Stand 60 is adapted to receive an inserted PTPED 100. In another embodiment, stand 60 may be configured to be angle adjustable, analogous to rotating sockets, such as a shoulder joint, so as to enable PTPED 100 to be oriented in a variety of angled positions. The angle adjustability of stand 60 can provide, in one embodiment, “hands-free” operation of PTPED 100, in contrast with the hand held embodiment of PTPED 100 shown in FIG. 5A. It is appreciated that in one embodiment, stand 60 can be configured to provide an electrical and communicative interconnection with PTPED 100. In one embodiment, stand 60 can be configured to receive wireless communications via nearly any wireless communication protocol, e.g., IR (infrared) or Bluetooth wireless. In another embodiment, stand 60 can be configured as non-electronic, such that stand 60 provides passive vertical or angle adjustable positioning of PTPED 100. In the present example, stand 60 is shown to be of a circular shape. However, it is appreciated that stand 60 may be of nearly any shape or size, with the proviso that it functions analogously.

FIG. 5C depicts PTPED 100 in a vertical orientation, analogous to PTPED 100 in FIG. 5B, supported by stand 60, in one embodiment of the present invention. In this example, keyboard 70 and mouse 80 are configured to communicate with PTPED 100 via wireless communication 64. Nearly any wireless communication may be implemented, including but not limited to IR and Bluetooth wireless connections. In one embodiment, PTPED 100 is configured to transceive wireless communication. In another embodiment, stand 60 is configured to transceive wireless communication. In another embodiment, PTPED 100 can be configured to transceive one type of wireless communication and stand 60 can be configured to transceive another type of wireless communication. In yet another embodiment, both PTPED 100 and stand 60 can be configured to transceive multiple wireless communication protocols.

Still referring to FIG. 5C, it is appreciated that keyboard 70 and mouse 80 are configured with wireless communication functionality. Accordingly, a user may control and interact with web page 551 by using a combination of keystrokes via keyboard 70 or a user may interact with web page 551 by controlling the cursor via mouse 80, or in a combination of mouse 80 and keyboard 70.

While the above described embodiments of the present invention are depicted and described as being intercommunicatively coupled using a wireless communication protocol, it is appreciated that in other embodiments, a physical (hard-wired) connection can be utilized to provide communication functionality between PTPED 100 and keyboard 70, mouse 80, and cradle 60. It is further appreciated that numerous types of physical connections can be utilized, including but not limited to, a serial interface, a USB (universal serial bus) interface, an IEEE 1394 interface, a parallel interface, and the like.

FIG. 6 is a functional block diagram of the components and circuitry a portable electronic device 650, e.g., PTPED (portable electronic device) 100 of FIGS. 3A and 3B, in one embodiment of the present invention. Portable electronic device 650 includes an address/data bus 609 for communicating information. Portable electronic device 650 further includes a central processor 601, coupled with bus 609, for processing information and instructions. Portable electronic device 650 also includes a volatile memory 603 (e.g., random access memory, RAM) coupled with the bus 609 for storing information and instructions for the central processor 601, and a nonvolatile memory 602 (e.g., read only memory, ROM) coupled with the bus 609 for storing static information and instructions, for the processor 601. Portable electronic device 650 also includes an optional data storage device 604 (e.g., hard disk drive, compact flash, SD (secure digital/data) or MMC (multimedia card)) coupled with the bus 609 for storing information and instructions. Device 604 can be removable. As described above, portable electronic device 650 also contains display projection apparatus 605 (e.g., display projection device 306 of FIGS. 3B and 4) coupled to the bus 609 for displaying information.

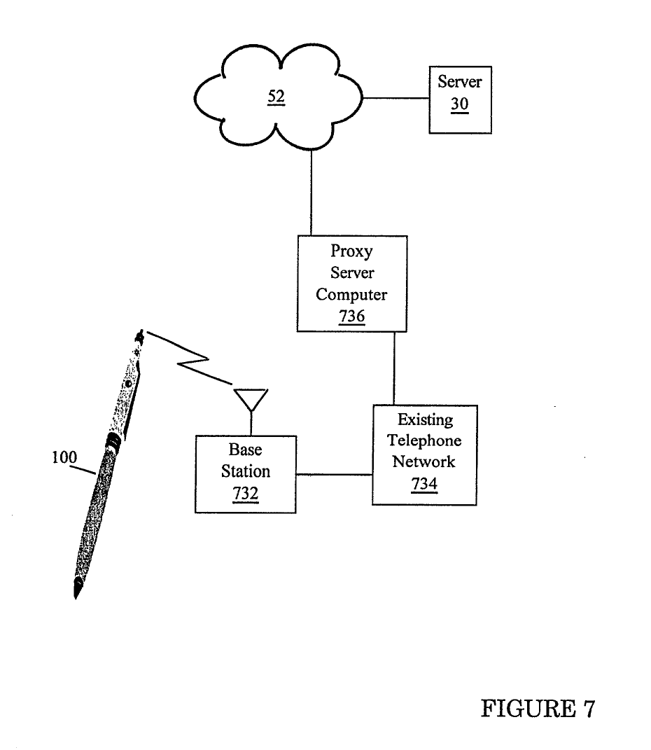

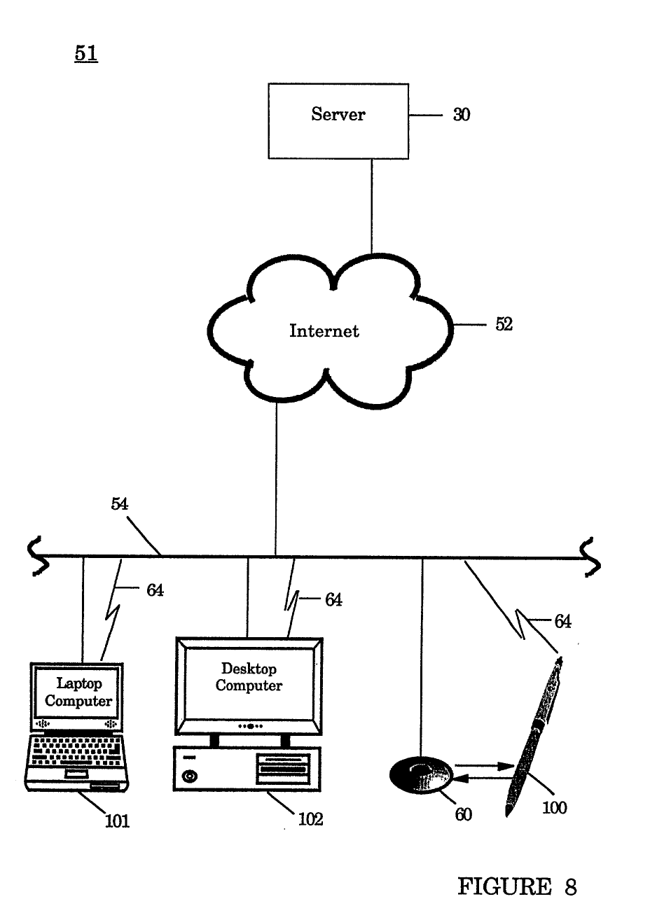

With reference still to FIG. 6A, portable electronic device 650 also includes a signal transmitter/receiver device 608, which is coupled to bus 609 for providing a physical communication link between a portable electronic device 650, (e.g., PTPED 100 of FIGS. 3A and 3B), and a network environment (e.g., network environments 50 and 51 of FIGS. 7 and 8, respectively). As such, signal transmitter/receiver device 608 enables central processor unit 601 to communicate wirelessly with other electronic systems coupled to the network. It should be further appreciated that the present embodiment of signal transmitter/receiver device 608 is well suited to be implemented in a wide variety of ways. For example, signal transmitter/receiver device 608 could be implemented as a wireless modem. In another embodiment, signal transmitter/receiver device 608 could be implemented as a Bluetooth configured device, (e.g., FIG. 6B).

In one embodiment, portable electronic device 650 includes a communication circuit 615 coupled to bus 609. Communication circuit 615 includes an optional digital signal processor (DSP) 620 for processing data to be transmitted or data that are received via signal transmitter/receiver device 608. Alternatively, processor 601 can perform some or all of the functions performed by DSP 620.

Also included in portable electronic device 650 of FIG. 6A is an optional alphanumeric input device 606, e.g., input device 304 of FIG. 3A, that, in one embodiment, is a handwriting memory device, e.g., handwriting memory unit 304 of FIG. 3A, adapted to interpret a users handwriting and to act in accordance with for instance. In another embodiment, alphanumeric input device 606 is configured as an OCR (optical character recognition) device, e.g., OCR 304 of FIG. 3A. Alphanumeric input device 606, when configured as OCR 304 is adapted to scan and input information into PTPED 100. In another embodiment, alphanumeric input device 606 can be an ink/pencil combination type of writing implement, e.g., ink and/or pencil writing implement 304 of FIG. 3A, and is not coupled to bus 609. Portable electronic device 650 also includes an optional cursor control or directing device (onscreen cursor control 607) coupled to bus 609 for communicating user input information and command selections to processor 601. In one implementation, on-screen cursor control device 607 is a laptop-style thumb stick or joystick, e.g., CPD (cursor placement device) 303 of FIG. 3A. Onscreen cursor control device 607 is capable of registering a position and display that position within a display generated by a display projection apparatus, e.g., display projection apparatus 306 of FIG. 4. Display projection apparatus 605 is suitable for generating graphic images and alphanumeric characters recognizable to the user.

Still referring to FIG. 6A, a display projection controller 610 is shown, also coupled to bus 609. Display projection controller 610 is configured to properly project the projected display, such that regardless of the orientation of the PTPED 100 (being held horizontally, vertically, or held in an angled position), the projected display is adjusted for correct viewing, thus readily viewable by a user. Further coupled to bus 609 is voice input device 611, e.g., MISP (microphone/speaker) 302 of FIG. 3A, for receiving verbal commands from a user, and interpreting those commands to initiate processor 601 for performing specific actions and processes.

FIG. 6B is a functional block diagram of wireless communication apparatus 608 of portable electronic device 100. In one embodiment of the present invention (the “Bluetooth embodiment”), transceiver 608 is a Bluetooth device comprising a digital component (e.g., a Bluetooth controller) and an analog component (e.g., a Bluetooth radio).

In the present embodiment, transceiver 608 comprises antenna 625 for receiving or transmitting radio signals, a radio frequency (RF) module 621, a link controller 622, a micro-controller (or central processing unit) 623, and an external interface 624. In one embodiment of the present invention, transceiver 608 is integrated within and coupled by a system bus 609 to portable electronic device 650, e.g., PTPED 100. It should be appreciated that, when configured with Bluetooth wireless function, PTPED 100 can interact with almost any portable electronic device (e.g., a host device such as a computer system or similar intelligent electronic device, a printer, a fax machine, etc.). However, it is appreciated that in another embodiment, transceiver 608 may be externally coupled to a PTPED 100.

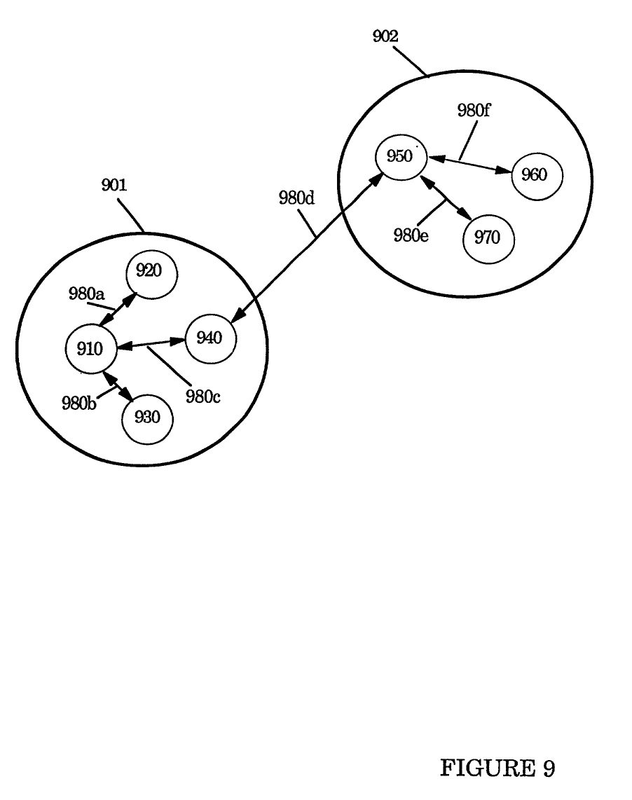

In the Bluetooth embodiment, RF module 621 is a Bluetooth radio. The Bluetooth radio can provide: a bridge to existing data networks, a peripheral interface, and a mechanism to form piconets of connected devices away from fixed network infrastructures (see FIG. 9).

In the present embodiment, link controller 622 is a hardware digital signal processor for performing baseband processing as well as other functions such as Quality-of-Service, asynchronous transfers, synchronous transfers, audio coding, and encryption.

In one embodiment, micro-controller 623 is an application specific integrated circuit (ASIC). In the Bluetooth embodiment, micro-controller 623 is a separate central processing unit (CPU) core for managing transceiver 108 and for handling some inquiries and requests without having to involve the host device. In the Bluetooth embodiment, micro-controller 623 runs software that discovers and communicates with other Bluetooth devices via the Link Manager Protocol (LMP). The LMP provides a number of services including sending and receiving of data, inquiring of and reporting a name or device identifier, making and responding to link address inquiries, connection setup, authentication, and link mode negotiation and setup. The LMP also can be used to place transceiver 608 in “sniff” mode, “hold” mode, “park” mode or “standby” mode.

With reference still to FIG. 6B, in the present embodiment, interface 624 is for coupling transceiver 608 to portable electronic device 650 via bus 609 in a suitable format (e.g., USB, PCMCIA, PCI, CardBus, PC Card, etc.). In the present embodiment, interface 624 runs software that allows transceiver 608 to interface with the operating system of portable electronic device 650, e.g., PTPED 100.

Exemplary Network Environment

FIG. 7 is a block diagram of an exemplary network environment 50 including PTPED (pen-type portable electronic device) 100 in accordance with one embodiment of the present invention. PTPED 100 is, in one embodiment, the shape of a pen, also known as pen-like or pen-type computer system. In one embodiment, PTPED (pen-type portable electronic device) 100 has the ability to transmit and receive data and information over a wireless communication interface (e.g., a radio interface). For purposes of the present application, the embodiments of the present invention are not intended to be limited solely to pen-like or pen-type electronic devices. Instead, the present invention is also intended to include any mobile electronic device. Such mobile devices include but are not limited to pagers and paging systems, wireless and cellular telephones, electronic address books, and numerous other mobile devices which may have the ability to wirelessly communicate with a network. As such, for purposes of the present application, the terms “portable electronic device” and “portable computer” and “mobile device” will be considered synonymous and will be used interchangeably.

Base station 732 can be both a transmitter and receiver base station, which can be implemented by coupling it into an existing public telephone network 734. Implemented in this manner, base station 732 enables PTPED 100 to communicate with a proxy server computer system 736, which is coupled by wire to the existing public telephone network 734. Furthermore, proxy server computer system 736 is coupled to the Internet 52, thereby enabling PTPED (portable electronic device) 100 to communicate with the Internet 52. When communicating with a Web site over Internet 52, protocols such as CTP (Compact Transport Protocol) and CML (Compact Markup Language) can be used by PTPED 100 in the present embodiment.

It should be appreciated that one of the functions of proxy server 736 is to perform operations over the Internet 52 on behalf of PTPED (portable electronic device) 100. For example, proxy server 36 has a particular Internet address and acts as a proxy device for PTPED 100 over the Internet 52.

It should be further appreciated that other embodiments of a communications network, planned or envisioned, may be utilized in accordance with the present invention. For example, a wireless connection may be made from PTPED (portable electronic device) 100 directly to the Internet 52.

The data and information which are communicated between base station 732 and PTPED 100 are the same type of information and data that can conventionally be transferred and received over a public telephone wire network system. Additionally, in FIG. 7, the existing telephone network could also be a packet-based network, utilized by some conventional portable electronic devices. However, a wireless communication interface is utilized to communicate data and information between PTPED 100 and base station 732. It should be appreciated that one embodiment of a wireless communication system in accordance with the present invention is the Mobitex wireless communication system. It should be further appreciated that another embodiment of a wireless communication system in accordance with the present invention is the Bluetooth wireless communication system, as is described in FIGS. 9-12. Furthermore, any nearly any wireless network, in addition to the two listed above, can support the functionality to be disclosed herein.

FIG. 8 illustrates another embodiment of a system 51 that can be used in conjunction with various embodiments of the present invention. System 51 comprises a host computer system which can either be a desktop unit 102 as shown, or, alternatively, can be a laptop system 101. Optionally, one or more host computer systems can be used within system 51. Host computer systems 101 and 102 are shown connected to a communication bus 54, which in one embodiment can be a serial communication bus, but could be of any of a number of well known designs, e.g., a parallel bus, Ethernet Local Area Network (LAN), etc. Optionally, bus 54 can provide communication with the Internet 52 using a number of well-known protocols.

Importantly, bus 54 is also coupled to a stand 60 for receiving and initiating communication with portable electronic device 100. In one embodiment, stand 60 provides an electrical and mechanical communication interface between bus 54 (and anything coupled to bus 54) and portable electronic device 100 for two-way communications. It is appreciated that in another embodiment, stand 60 does not provide an electrical and mechanical communication interface, but rather provides a passive support mechanism for standing portable electronic device 100 in a vertical orientation. PTPED (portable electronic device) 100 may instead be coupled to host computer systems 101 and 102 via a wireless (radio) connection. PTPED 100 also contains a wireless infrared communication mechanism 64 for sending and receiving information from other devices. Additionally, in FIG. 8, the existing telephone network could also be a packet-based network utilized by some conventional portable computer systems.

With reference to both FIGS. 7 and 8, it is appreciated that PTPED 100 can be used in a network environment combining elements of networks 50 and 51. That is, as has been shown above, and as will be further described below, portable electronic device 100 can include both a wireless infrared communication mechanism and a signal (e.g., radio) receiver/transmitter device.

Exemplary Bluetooth Platform

It is appreciated that in one embodiment, PTPED (portable electronic device) 100 is configured with Bluetooth wireless communication functionality. FIG. 9 illustrates the topology of a network of devices coupled using wireless connections in accordance with one embodiment of the present invention. In the parlance of Bluetooth, a collection of devices connected in a Bluetooth system are referred to as a “piconet” or a “subnet.” A piconet starts with two connected devices, such as a computer system and a cellular phone, and may grow to eight connected devices. All Bluetooth devices are peer units; however, when establishing a piconet, one unit will act as a master and the other(s) as slave(s) for the duration of the piconet connection.

A Bluetooth system supports both point-to-point and point-to-multi-point connections. Several piconets can be established and linked together in a “scatternet,” where each piconet is identified by a different frequency hopping sequence. All devices participating on the same piconet are synchronized to their respective hopping sequence.

Accordingly, devices 910, 920, 930 and 940 are coupled in piconet 901 using wireless connections 980a-c. Similarly, devices 950, 960 and 970 are coupled in piconet 902 using wireless connections 980e-f. Piconet 901 and piconet 902 are coupled using wireless connection 980d. Devices 910-970 can be printers, personal digital assistants (PDAs), desktop computer systems, laptop computer systems, cell phones, fax machines, keyboards, joysticks, and, in one embodiment of the present invention; portable computer systems, portable electronic devices, or virtually any other digital device. In the present embodiment, devices 910-970 are Bluetooth devices; that is, they are equipped with a Bluetooth radio transceiver, or they are adapted to communicate with Bluetooth devices (“Bluetooth-enabled”). That is, the Bluetooth radio transceiver may be integrated into a device, or it may be coupled to a device.

Bluetooth radios operate in the ISM (Industrial, Scientific, Medical) band at 2.4 GHz. A frequency hop transceiver is applied to combat interference and fading. Bluetooth uses a packet-switching protocol based on a frequency hop scheme with 1600 hops/second. Slots can be reserved for synchronous packets. A packet nominally covers a single slot, but can be extended to cover up to five slots. Each packet is transmitted in a different hop frequency. The entire available frequency spectrum is used with 79 hops of one (1) MHz bandwidth, defined analogous to the IEEE (Institute of Electronic and Electrical Engineering) 802.11 standard. The frequency hopping scheme is combined with fast ARQ (Automatic Repeat Request), cyclic redundancy check (CRC) and Forward Error Correction (FEC) for data.

In the present embodiment, before any connections between Bluetooth devices are created, all devices are in standby mode. In this mode, an unconnected unit “listens” for messages at a regular rate (e.g., every 1.28 seconds) on a set of hop frequencies defined for that unit. The hold mode is a power saving mode that can be used for connected units if no data need to be transmitted. The sniff and park modes are also low power modes. In the sniff mode, a device listens to the piconet at a reduced rate (relative to the regular rate), thus reducing its duty cycle. The sniff interval is programmable and depends on the application. In the park mode, a device is still synchronized to the piconet but does not participate in the traffic.

A connection between devices is made by a “page” message if the address is already known, or by an “inquiry” message followed by a subsequent page message if the address is unknown.

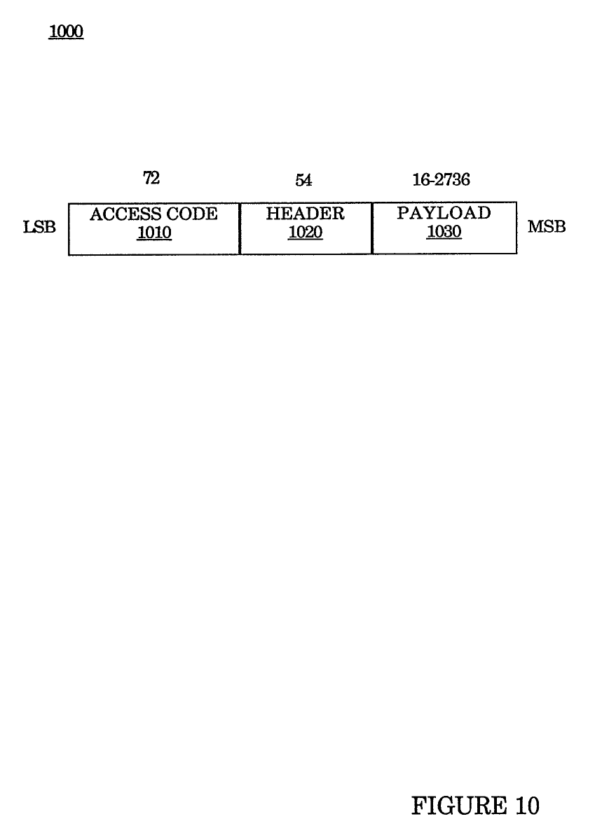

FIG. 10 illustrates a format for a data packet 400 in accordance with one embodiment of the present invention. In the present embodiment, packet 1000 consists of three fields: a 72-bit access code 1010, a 54-bit header 1020, and a payload 1030 of variable length (2-342 bytes, or 16-2736 bits). Packet 1000 may consist of the access code only, a shortened version of the access code, the access code and the header, or the access code, header and payload.

Access code 1010 is used for synchronization, offset compensation and identification. Access code 1010 identifies all packets exchanged on the channel of a piconet (e.g., piconet 901 and 902 of FIG. 9). All packets sent in the same piconet are preceded by the same channel access code.

Payload 1030 carries user information and control information. In a data packet, payload 1030 also contains data. A cyclic redundancy check (CRC) is added to each payload that contains data to verify the success of the reception of the data packet.

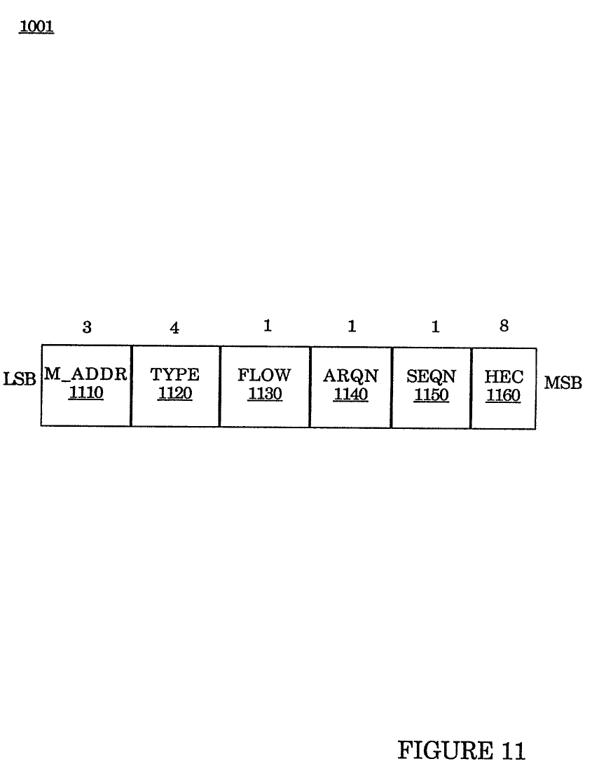

FIG. 11 illustrates a format of header 1001 in a header 1020 of data packet 1000 (FIG. 10) in accordance with one embodiment of the present invention. Header 1001 contains lower-level link control information. In the present embodiment, header 1001 consists of six (6) fields: a 3-bit sub address (M_ADDR 1110), a 4-bit packet type (TYPE 1120), a 1-bit flow control bit (FLOW 1130), a 1-bit acknowledge indication (ARQN 1140), a 1-bit sequence number (SEQN 1150), and an 8-bit header error check (HEC 1160). In this embodiment, the total header information consists of 18 bits, but it is protected with a ⅓ forward-error correction (FEC) coding resulting in a 54-bit header length.

In the present embodiment, M_ADDR (Medium Access Control Address) 1110 represents a Medium Access Control (MAC) address and is used to distinguish between the participant devices of a piconet. Typically, several slave devices (“slaves”) are connected to a single master device (“masters”). To identify each slave separately, each slave is assigned a temporary MAC address for the duration of the connection. Packets exchanged between the master and a slave all carry the M_ADDR of this slave. The all-zero address is reserved for broadcasting purposes.

In the Bluetooth embodiment, a link type is used to define what type of packets can be used on a particular link. The Bluetooth technology supports two link types: Synchronous Connection Oriented (SCO) used primarily for voice, and Asynchronous Correctionless (ACL) used primarily for data. In the present embodiment, sixteen different types of packets can be distinguished. The 4-bit TYPE 1120 code specifies which packet type is used. The interpretation of the TYPE 1120 code depends on the physical link type associated with the packet. First, it is determined whether the packet is a SCO link packet or an ACL link packet. Then, it is determined which of the SCO packet types or ACL packet types is being dealt with. The TYPE 1120 code also reveals how many slots the current packet will occupy.

In the present embodiment, the FLOW 1130 bit is used for flow control over the ACL link. When the receiver buffer for the ACL connection in the receiving device is full and is not emptied by the link support unit, a STOP indication (FLOW=0) is returned to stop the transmission of data temporarily. In this embodiment, the STOP signal only concerns ACL packets, and so packets including only link control (POLL and NULL packets) or SCO packets can still be received. When the receive buffer is empty, a GO indication (FLOW=1) is returned. When no packet is received or the received header is in error, a GO is assumed implicitly.

In the present embodiment of the present invention, the ARQN 1140 bit is an acknowledge field to inform the transmitting device whether the reception of the data packet in the preceding slot was successful (ARQN=1) or unsuccessful (ARQN=0). When no valid ARQN field is received, ARQN=0 is assumed implicitly. ARQN=0 is the default value. ARQN 1140 is piggy-backed in the return data packet (e.g., an acknowledge signal) sent to the transmitting device by the receiving device. The success of the reception is checked by the receiving device by means of the CRC which is added to each payload that contains data. In the present embodiment, an unnumbered ARQ scheme is used, which means that ARQN 1140 relates to the packet just received.

In the present embodiment, SEQN (Sequential Numbering Scheme) 1150 is a numbering field to distinguish new packets from retransmitted packets. The SEQN 1150 bit is toggled by the transmitting device for each new packet transmission. A retransmitted packet keeps the same SEQN 1150 bit. If two consecutive packets are received with the same SEQN 1150 bit, the second packet is ignored by the receiving device.

In the present embodiment, each header has a header error check (HEC) 1160 so that the receiving device can check the header integrity. If the HEC 1160 does not check, the entire packet is disregarded by the receiving device.

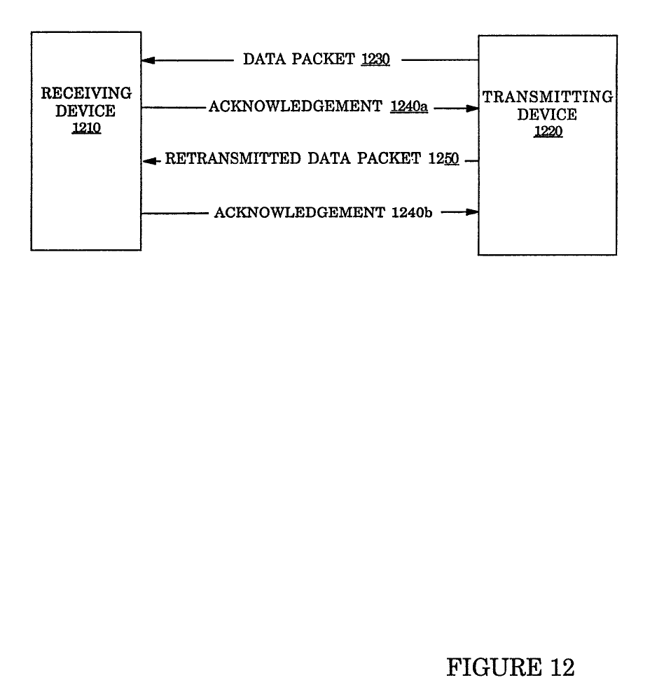

FIG. 12 diagrams a transfer of data packets between receiving device 1210 and transmitting device 1220 in accordance with one embodiment of the present invention. In one embodiment, receiving device 1210 and transmitting device 1220 are Bluetooth devices or Bluetooth-enabled devices.

In the present embodiment, an unnumbered ARQ scheme is applied in which a data packet transmitted in one slot is directly acknowledged by the receiving device in the next slot. For a data transmission to be acknowledged (ARQN=1), both the HEC 1160 and the CRC must check; otherwise a negative acknowledge NAK (ARQN=0) is returned (refer to FIG. 11).

Continuing with reference to FIG. 12 and with reference also to FIGS. 10 and 11, in the present embodiment, data packet 1230 is received by receiving device 1210. Data packet 1230 has a data payload 1030 including a CRC. In one embodiment, link controller 220 (FIG. 6B) of receiving device 1210 first checks the HEC 1160 in data packet 1001. If the HEC 1160 checks, the payload CRC is checked. If the CRC checks as well, the ARQN 1140 field in the return packet (e.g., acknowledgment 1240a) is set to a binary 1 (ARQN=1). Otherwise the ARQN 1140 field in acknowledgment 1240a is set to binary zero (ARQN=0). When the HEC 1160 and CRC check, the payload 1001 is accepted, provided SEQN 1150 in the packet header 1020 differs from the SEQN 1150 in the last successfully received packet (e.g., the data packet preceding data packet 1230). Otherwise the payload 1030 is discarded.

On reception of acknowledgment 1240a, in one embodiment, link controller 220 (FIG. 6B) of transmitting device 1220 first checks the HEC of acknowledgment 1240a. If the HEC checks, it reads the ARQN field in the header of acknowledgment 1240a. If ARQN=1, the sender toggles SEQN 1150 in the next data packet and transmits that data packet in the next transmit slot. If the HEC does not check or a NAK (ARQN=0) has been received, SEQN 1150 is not toggled and the previous payload 1030 is retransmitted (that is, data packet 1230 is resent as retransmitted data packet 1250). Upon receipt of retransmitted data packet 1250 by receiving device 1210, the HEC and CRC are checked, the SEQN bit is read, and acknowledgment 1240b is sent. The contents of acknowledgment 1240b are dependent on the HEC and CRC results, as described above. This scheme is repeated for each data packet until all data packets are successfully transmitted and received.

The ARQ scheme described above is carried out separately between the master and each slave. The master receives acknowledgment data of master-to-slave information directly in the slave-to-master slot following the master-to-slave slot. Acknowledgment data of slave-to-master information are received in the next master-to-slave slot in which the master addresses the slave.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A display projection system comprising:
an image generator for providing a beam, said beam comprising data to be displayed; and
an optical component to provide collimation of said beam, wherein said data is viewable via a projected display and said display projection system is implementable in a portable electronic device.

2. The display projection system as recited in claim 1 further comprises an optional optical attenuator.

3. The display projection system as recited in claim 1 further comprises an adjustable reflecting mechanism for directing said beam.

4. The display projection system as recited in claim 1 wherein said image generator is laser-type image generator.

5. The display projection system as recited in claim 4 further comprises a scanning mechanism for painting said beam.

6. The display projection system as recited in claim 1 wherein said image generator is a transmissive liquid crystal display projection image generator.

7. The display projection system as recited in claim 1 wherein said image generator is a reflective digital light panel projection image generator.

8. The display projection system as recited in claim 3 wherein said adjustable reflecting mechanism is further adapted to control said scanning of said beam.

9. The display projection system as recited in claim 3 wherein said adjustable reflecting mechanism is further adapted to focus said image generated.

10. A display system for providing a projected display for a portable electronic device comprising:
an image generator coupled to said portable electronic device, said image generator for providing a beam, said beam comprising data for display; and
an optical component coupled to said portable electronic device for collimation of said beam, wherein said beam is projected such that said data is viewable via said projected display.

11. The display system of claim 10 further comprises an optional optical attenuator.

12. The display system of claim 10 further comprising an adjustable reflecting mechanism for directing said beam and for directing a scanning mechanism, said adjustable reflecting mechanism further adapted to provide focusing of said projected display

13. The display system of claim 10 wherein said image generator is a laser-type image generator, wherein said laser-type image generator further comprises a scanning mechanism coupled to said portable electronic device for painting said beam.

14. The display system of claim 10 wherein said image generator is a transmissive liquid crystal display projection image generator.

15. The display system of claim 10 wherein said image generator is a reflective digital light panel projection image generator.

16. A portable electronic device comprising:
a communication device coupled to said portable electronic device enabling intercommunication with other electronic devices;
an input device coupled to said portable electronic device;
a verbal input device coupled to said portable electronic device for receiving voice commands; and
a display system coupled to said portable electronic device for providing a projected display comprising:
an image generator for providing a beam, said beam comprising data for display; and
an optical component for collimation of said beam;
wherein said display system projects said data, such that said data is viewable in a projected display, said display projected onto a surface, said surface external of said portable electronic device.

17. The portable electronic device of claim 16 wherein said display system further comprises an adjustable reflecting mechanism for directing said beam and directing a scanning mechanism.

18. The portable electronic device of claim 16 wherein said display system further comprises an optional optical attenuator.

19. The portable electronic device of claim 16 wherein said communication device is a wireless communication device.

20. The portable electronic device of claim 16 wherein said wireless communication device is a Bluetooth device.

21. The portable electronic device of claim 16 wherein said input device is configured as a handwriting memory device.

22. The portable electronic device of claim 16 wherein said input device is configured as a optical character recognition device.

23. The portable electronic device of claim 16 wherein said image generator is a laser-type image generator.

24. The portable electronic device of claim 23 wherein said laser-type generator further comprises a scanning mechanism for painting said beam.

25. The portable electronic device of claim 16 wherein said image generator is a transmissive liquid crystal display projection image generator.

26 The portable electronic device of claim 16 wherein said image generator is a reflective digital panel projection image generator.

27. The portable electronic device of claim 16 wherein the shape and size of said portable electronic device is pen-like.
